(19) United States
(12) Patent Application Publication
(10) Pub. No.: US 2007/0284924 A1
(43) Pub. Date: Dec. 13, 2007

(54) Fitting for Child Safety Seat

(75) Inventors: Jonathan Morris Gold, London (GB); Paul Andrew Sharp, Coventry (GB); Geoffrey Wilfred Barley, Wiltshire (GB)

Correspondence Address: MCGRATH, GEISSLER, OLDS & RICHARDSON, PLLC, P.O. BOX 1364, FAIRFAX, VA, 22038-1364, US

(73) Assignee: Catalyst Developments (Europe) Ltd., London (GB)

(21) Appl. No.: 10/594,950

(22) PCT Filed: Mar. 29, 2005
(86) PCT No.: PCT/EP05/03255

§ 371 Date: Jan. 19, 2007

(30) Foreign Application Priority Data
Mar. 31, 2004 (GB) 0407248.4

(51) Int. Cl. B60N 2/28; A47C 7/02; B60N 2/26

(52) U.S. Cl. 297/253; 297/250.1; 297/256.16

(57) ABSTRACT

There is provided a fitting for a child safety seat for use with a vehicle seat comprising a body; provided to said body, a first connector for connecting to an anchorage of a child safety seat; and provided to the body and spaced from the first connector, a second connector for connecting to an anchorage of a vehicle seat. There is also provided a child safety seat for use with a vehicle seat comprising a base arranged for secure fitting to said vehicle seat; a child seat arranged for secure placement of a child therein; and a mounting for mounting said child seat to said base, wherein said base is provided with an anchorage for connecting a connector of a fitting thereto. The child safety seat and fitting may comprise a kit of parts.

### TECHNICAL FIELD

The present invention relates to a fitting for a child safety seat of the kind that may be fitted to the seat of a vehicle. In particular, the present invention relates to a fitting for securing the child safety seat to an anchorage point provided to the vehicle seat, wherein that fitting is reversibly anchorable to the child safety seat.

### BACKGROUND TO THE INVENTION

Child safety seats for use with vehicles are well known in the prior art. Such seats are typically designed to be fitted to the front or rear seat of a vehicle and to provide a safe and secure carriage environment for the child. At minimum, the seat enables the child to be securely fastened within the seat such that in the event of an emergency stop or vehicle accident the child remains securely in the safety seat, which itself remains securely fitted to the vehicle seat.

Secure fitting of the child safety seat to the vehicle seat is achievable in two distinct ways. The traditional method of fitting relies on securing the child safety seat to the vehicle seat by means of the adult safety belt provided to the vehicle seat. This fitting method (hereinafter ‘adult safety belt fitting’) has been extensively used with child safety seats in vehicles for many years. A second method of fitting involving the provision of standard form anchor bars to the vehicle seat for receipt of standard form connectors provided to the child safety seat has been more recently proposed (hereinafter ‘connector to anchor fitting’). An international standard, the ISOfix standard, has been defined by the International Standards Organization to standardize the format, size and shape of the both the anchor bars and connectors of the fitting. The intention is that relevant vehicle seats of modern vehicles regardless of type or manufacturer incorporate the standard ISOfix anchor bars. In tandem, child safety seats will incorporate the standard ISOfix connectors for fitting thereof to the standard ISOfix anchor bars. Various countries have adopted or adapted the ISOfix standard, which for example, has been implemented in the United States under the name LATCH. Throughout this present description, reference to ISOfix standard is therefore to all of these adoptions, adaptations and implementations of the ISOfix standard to meet local country requirements.

Whilst the ISOfix standard is being implemented on a gradual basis some vehicles (particularly older ones) do not have ISOfix anchor bars. This means that the child safety seat must be fitted using the traditional ‘adult safety belt fitting’ approach and that any ISOfix connectors provided to that child safety seat are effectively redundant.

The Applicant has therefore realized that it is desirable that a child safety seat be provided that may reversibly receive an ISOfix fitting, typically provided as a ‘cassette’ for docked receipt by the child safety seat. The child safety seat and ISOfix cassette fitting may be sold separately and fitted for use, as needed. In one instance, where the purchaser has a vehicle that enables only ‘adult safety belt fitting’ the cassette fitting will not be purchased and the cost of any permanently attached ISOfix fitting is avoided. Where however, that purchaser acquires another (e.g. more modern) vehicle that includes ISOfix anchorages the cassette fitting may be purchased and docked to the child safety seat to enable ISOfix ‘connector to anchor’ fitting thereof to the ISOfix anchorages of the vehicle seat.

It is an object of the present invention to provide a fitting that is reversibly receivable by a child safety seat to enable ‘connector to anchor’ fitting of that child safety seat to anchor bars provided to a vehicle seat.

### SUMMARY OF THE INVENTION

According to a first aspect of the present invention there is provided a fitting for a child safety seat for use with a vehicle seat comprising

a body;

provided to said body, a first connector for connecting to an anchorage of a child safety seat;

and provided to the body and spaced from the first connector, a second connector for connecting to an anchorage of a vehicle seat.

There is described a fitting for a child safety seat for use with a vehicle seat. The fitting is suitable for providing a standard fixing system (e.g. ISOfix) to a child car seat that can be used with an anchorage provided to a vehicle seat as an alternative to fixing by means of an adult seat belt fixing. The fitting has connectors that are suitably arranged for quick and easy engage and disengage with both the child car seat and the anchorage provided to the vehicle.

The fitting comprises a body. Suitably, the body has elongate form and the first and second connectors are provided at opposite ends of the elongate form.

Suitably, a first end of the body is generally shaped for ‘docking’ receipt with a cavity provided to a child safety seat, in which a recessed anchorage (e.g. anchor bar) is provided. That is to say, that end of the fitting that has the first connector is sized and shaped for receipt within a cavity of the child safety seat to enable connection to a recessed anchorage provided within the cavity.

In one aspect, the body of the fitting has the form of a H-shape. That is to say, the overall form is of two elongate fittings, each having first and second connectors provided to opposite ends thereof, and the elongate fittings joined by one or more lateral crosspieces to form an overall H-shaped configuration. The crosspiece or crosspieces may, in one aspect comprise a simple bar, but for added rigidity and to prevent relative rotation of the two fittings, it has been found to be preferable to use a crosspiece having box girder constructional form. Alternatively, other pieces such as struts and links may also be used to add rigidity to the H-form body.

Further the H-form fitting may be provided (e.g. at the crosspiece(s) or at the body thereof with one or more features design to provide anti-rotate function capability when the H-form fitting is fitted to the child safety seat. Suitable anti-rotation features include one or more arms or mountings protruding from the fitting and contacting/engaging with the base of the child safety seat.

In aspects, the body of the fitting(s) and/or the crosspiece is provided with guide elements for guiding receipt of the connector(s) thereof by their respective anchorage(s). Similar guide elements may also be provided to the child safety seat and/or vehicle seat.

Provided to the body, there is a first connector for connecting to an anchorage of a child safety seat; and provided to the body and spaced from the first connector, a second connector for connecting to an anchorage of a vehicle seat.

Thus, in use, the second connector connects to an anchorage of a vehicle seat and the first connector to an anchorage provided to the child seat. Suitably, access to disengage the fitting from the child seat is arranged such that misuse scenarios are minimised (e.g. a child sitting in the child seat would be unable to disengage the fitting).

The first and second connectors may take any suitable form for connecting to their respective anchorages (e.g. anchor bars). Thus the connectors may take the form of buckles, latches, clasps, locking jaws, hooks and other suitable attachment or connection means.

A suitable anchorage that conforms to the ISOfix standard comprises a 6 mm diameter round anchor bar. A suitable vehicle seat anchorage comprises such an anchor bar fitted to (e.g. extending from) the vehicle seat (or vehicle seat frame) structure. Typically, a vehicle seat is provided with two anchorages that are spaced apart at a spacing that is again in accord with ISOfix standard.

Suitably, at least the second connector of the fitting conforms to the ISOfix standard for connectors and is arranged for connecting to an anchorage on the vehicle seat that also meets the requirements of ISOfix standard.

Preferably, one or both of the first and second connectors is a connector meeting the requirements of the ISOfix standard and each being arranged for connecting to an anchorage that also meets the requirements of ISOfix standard.

Typically, two fittings of the type described herein are required to be provided to the child seat to enable anchoring of that seat to left and right hand anchorages provided to the vehicle seat.

The body of the fitting acts to space the first and second connectors apart from each other. It has been appreciated that because of variability in the location of the anchorage(s), particularly variability in the location of the vehicle seat anchorage at the seats of different vehicle types, it can be advantageous to adapt the body of the fitting such as to provide for variable and/or adjustable spacing of the first and second connectors.

Thus, the body of the fitting herein is suitably provided with an adjuster for adjusting the spacing between the first and second connectors.

In one aspect, the adjuster allows for continuous adjustment of the spacing over a defined range of spacing distances. In another aspect, the adjuster allows for stepped adjustment of the spacing, again over a defined range of spacing distances.

In one aspect, the spacing adjuster comprises a ratchet and pawl mechanism.

In one aspect, the spacing adjuster comprises a sprung-loaded spacer pin that is movable between defined spacing positions. Typically, from two to five (e.g. three) spacing positions are defined.

In another aspect, the spacing adjuster comprises a screw adjuster.

It is desirable that the first and second connectors are readily arranged for the desired connection to their respective anchorages.

In one aspect, one or more of the first and second connectors locates within a recess defined by an open jaw (of the end of the body) such that when an anchorage (e.g. anchor bar) is received within the jaw, the form of the jaw directs the anchorage to the connector.

In one aspect, one or more of the first and second connectors is arranged such as to automatically lock onto the anchorages on being brought into contact therewith. One suitable automatic lock mechanism employs a rotationally mounted C-form jaw member shaped for receipt of an anchor bar and provided with lock means for locking the C-form member into a position in which, the anchor bar is so-received.

In one aspect, one or more release(s) is provided for ready release of the connector(s). Suitably, the release comprises a user actuator (e.g. button, switch, key or latch) coupled via a release mechanism to the connector. In use, the user actuates the actuator and thereby triggers the release mechanism to release the connector, which disconnects from its anchorage.

In one aspect, the release mechanism comprises a latch mechanism.

In one aspect, plural fittings may be joined to form a single unit (e.g. in the form of a H-frame). Such an arrangement aids guidance of the ends of the connectors when engaging the fitting with the anchorages provided at both the rear of the child car seat and the seat of the vehicle.

In use, it may be important that the fitting is used a particular way up (e.g. ISOfix anchorage-connector attachments are not symmetrical). In one aspect, this may be achieved by offsetting the crosspiece of a H-form body towards the bottom (making it impossible to fit the other way up). The crosspiece(s) of the H-form could also be offset fore-aft to ensure that connectors with plastic covers connect to the anchor(s) of the vehicle seat. Pictorial labels on the H-form would help.

In one aspect, the fitting may be guided into the rear of the base of the child seat and prevented from rotating relative to the seat by ensuring a tight fit, hence it being referred to as a ‘cassette’ fitting. In another aspect, the base of the child seat may be arranged such that some limited movement (e.g. rotation about a transverse axis) of the fitting is possible when the connector(s) connect to the anchorage(s) of the base of the child seat.

The fitting may be sold as a separate unit when a child safety seat is purchased, thus minimising weight and cost for people who only require adult seat belted fixing to the vehicle. The fitting may either be made available at point of purchase or at a later date should one later be required by the owner of the child seat. The fitting should be suitable for fitting by a layman.

It will be appreciated that the fitting herein is arranged for use with a child safety seat having one or more suitable anchorages.

Thus, according to another aspect of the present invention there is provided a child safety seat for use with a vehicle seat comprising

a base arranged for secure fitting to said vehicle seat;

a child seat shell arranged for secure placement of a child therein; and

a mounting for mounting said child seat shell to said base, wherein said base includes an anchorage for connecting a connector of a fitting thereto.

The child safety seat herein is designed to provide a safe and secure carriage environment for the child. In particular, the child safety seat is designed such that in the event of an emergency stop or vehicle accident the child remains safe and secure in the safety seat, which itself remains securely mounted to the vehicle seat.

The child safety seat is arranged for secure fitting (e.g. by its base) to a vehicle seat. The vehicle may for example, be a car, van, lorry, bus or coach but is most usually a car. The vehicle seat may be either a front or rear seat and has known seat form. The base of the child seat is itself sized and shaped to marry up, or at least to be readily receivable by the vehicle seat. Secure fitting of the base to the vehicle seat is by the fitting described herein.

Whilst it is desirable that the child safety seat is readily securable to the vehicle seat, ease of fitting and removal is less important than the security of fitting to the vehicle seat. In a typical usage mode the child safety seat is securely fitted to the vehicle seat and remains so fitted during the lifetime of use of the child seat product rather than being fitted and removed regularly.

The base is also arranged for receipt of the mounting and child seat shell described in more detail hereinafter. In one aspect, the base is provided with a furrow or basin therein (e.g. cut-away form) sized and shaped for ready receipt of the mounting for the child seat shell.

The child safety seat also comprises a child seat shell that is arranged for secure placement of a child therein. The shape and form of the child seat shell is generally conventional and typically comprises a seat shell base for support of the child's bottom and thighs and a seat shell back for support of the child's back. Wings are suitably provided to the seat shell base and seat shell back, the former sometimes functioning as arm rests for the child and the latter functioning to reduce freedom of child head/shoulder movement but principally to provide additional protective function (e.g. for the child's head) in the event of (e.g. a side impact) vehicle collision.

There is also suitably provided a mounting for mounting the child seat shell to the base. In one aspect, the mounting readily enables reversible mounting/demounting of the child seat shell from the base, although this is not always required.

As background, it is noted that child safety seats are generally of two types. The first type is often referred to in the industry as a ‘first stage’ (or Group 0+) seat and is designed for safe carriage of a child of up to about twelve to fifteen months with a weight of less than 13 kg. The usage mode for such ‘first stage’ seats is typically that the child safety seat functions as both a safety seat and an infant carrier with the child remaining stowed therein as the seat shell is placed in and removed from the vehicle. A ‘first stage’ child safety seat must thus be reversibly removable from the seat base (which remains fitted to the vehicle). The second type is often referred to in the industry as a ‘second stage’ (or Group I) seat and is designed for safe carriage of a child from about nine months to four years with a weight of from about 9 kg to 18 kg. The usage mode for such ‘second stage’ seats is typically that the child safety seat functions just as a vehicle safety seat and remains in the vehicle with the child being placed in and removed from the seat, which remains in situ in the vehicle.

Suitably, the mounting provides for both reversible reclining movement of the child seat shell relative to the base from an initial position to one or more reclined positions and reversible rotational movement of the child seat shell relative to the base to a loading position, which enables ease of placement of a child in the child seat shell. The reversible reclining and rotational movement are preferably independent of each other (i.e. each may be enabled independent of the other).

The reversible reclining movement of the child seat shell relative to the base is base from an initial, generally child-sitting position to one or more (e.g. from one to six) reclined positions. Thus, the reclining movement is typically a backwards-forwards movement relative to a normal sitting direction as would be defined by the configuration of the child seat, and is generally either a ‘child faces forward to direction defined by vehicle seat’ or less typically, but not inconceivably, ‘child faces backward to direction defined by vehicle seat’. Typically, the base remains static relative to the seat, to which it is securely fitted and the child seat moves relative thereto both the base and vehicle seat.

The reversible rotational movement of the child seat shell relative to the base is from a first position, in which the child seat is non-rotated (i.e. 0° rotation) relative to the normal sitting direction to a loading position, in which the child seat is rotated (i.e. >0° rotation) to a position that enables ease of placement of a child in the child seat. The rotation may be in a clockwise or anti-clockwise sense so that the vehicle seat may be rotated to either vehicle door opening. Suitably, in the loading position the child seat is rotated such that it faces, or nearly does so, the vehicle door thereby corresponding to a near 90° rotation relative to the normal sitting direction. In one aspect, the maximum degree of rotation corresponds to a near 90° rotation relative to the normal sitting direction. Suitably, the bottom part of the seat shell base (i.e. the seat pan) also remains in close relationship to the base (e.g. in a horizontal configuration, in use) during rotation thereof.

For a standard configuration of child seat rotational movement of the child seat shell can be more straightforward when the child seat shell is in the non-reclined (i.e. initial position). In one preferred aspect therefore, the mounting provides for both reclining movement of the child seat shell relative to the base from an initial position to one or more reclined positions and reversible rotational movement of the child seat relative to the base from said initial position to a loading position, which enables ease of placement of a child in the child seat shell.

Alternatively, for a standard configuration of child seat rotational movement of the child seat shell is more straightforward when the child seat shell is spaced (e.g. lifted upwards) from the base relative to its normal usage positioning. In another preferred aspect therefore, the mounting provides for each of reversible reclining movement of the child seat shell relative to the base from an initial position to one or more reclined positions; reversible spacing movement of the child seat shell relative to the base from said initial position to a spaced position; and reversible rotational movement of the child seat shell relative to the base from said spaced position to a loading position, which enables ease of placement of a child in the child seat shell.

It will be appreciated that the child safety seat herein may be used in essentially two modes, namely a ‘travel mode’ in which the child is secured in the child seat and a ‘loading/unloading’ mode in which the child is being placed into/removed from the child seat. In general terms, in the ‘travel mode’ the enabling of reclining movement of the child seat relative to the base is desirable whereas rotational movement thereof is either not desirable or entirely undesirable. Again in general terms, in the ‘loading/unloading mode’ the enabling of reclining movement of the child seat relative to the base is either not very desirable or entirely undesirable whereas rotational movement thereof is desirable.

It will also be appreciated that whilst user (i.e. parent or guardian) controlled reclining, rotational or in aspects, spacing movement of the child seat relative to the base is desirable as described herein, in the travel mode, particularly when the vehicle is moving it is essential that the child safety seat does not uncontrollably move about. Reversible locking and/or control mechanisms are therefore typically provided to control the various movements such that movement is enabled when desired but otherwise the child seat is locked in a particular position/configuration, which may be an intermediate position/configuration. Locking is certainly desirable during travel (i.e. when the vehicle is moving). Such locks and/or controls may therefore comprise reclining movement lock and/or control mechanisms, rotational movement lock and/or control mechanisms and in aspects, spacing movement lock and/or control mechanisms.

Preferably, the child safety seat is configured such that in the ‘travel mode’ in respect of the mounting, the reclining movement is locked into either the initial position or/any reclined position; the rotational movement is locked into the non-rotated (i.e. 0° rotation) position; and any spacing movement is locked into the non-spaced position.

The base of the child seat herein includes an anchorage for connecting a connector of a fitting (e.g. as described hereinbefore) thereto.

The anchorage may take any suitable form for enabling connection of a connector of the fitting thereto.

Preferably, the anchorage comprises an anchor bar. More preferably, the anchorage comprises an anchor bar that meets the requirements of the ISOfix standard.

Suitably, the anchorage locates within a cavity sized and shaped to receive at least the connector of said fitting. Preferably, the anchorage is recessed within said cavity, which cavity is sized and shaped to guide receipt of the connector of the fitting.

Suitably, the base of the child safety seat is provided with plural (e.g. two) anchorages, each for anchoring a connector of a fitting thereto. Alternatively, the base of the child safety seat is provided with a single anchorage of sufficient length to allow for anchoring of plural (e.g. two) connectors of a fitting thereto.

The fitting and child safety seat herein may be supplied as a kit of parts, or alternatively may be supplied separately.

In one aspect, for use with a child safety seat provided with plural (e.g. two) anchorages, a set comprising plural (e.g. two) separate fittings, each with first and second connectors, is provided for use therewith. A suitable kit of parts in this aspect thus, comprises a child safety seat and the plural (e.g. two) separate fittings.

In another aspect, for use with a child safety seat provided with plural (e.g. two) anchorages, a unitary body (e.g. H-form) arranged to comprise plural (e.g. two) spaced fittings, each with first and second connectors, is provided for use therewith. A suitable kit of parts in this aspect thus, comprises a child safety seat and the unitary body with spaced fittings.

The base of the child safety may also be supplied as a sub-assembly absent the child seat. Therefore according to a still further aspect of the present invention there is provided a base sub-assembly for child safety seat for use with a vehicle seat comprising

a base arranged for secure fitting to said vehicle seat; and

a mounting for mounting a child seat shell to said base,

wherein said base includes an anchorage for connecting a connector of a fitting thereto.

It will be appreciated that the base, child seat shell, mounting and fitting for the child safety seat herein may be manufactured and supplied separately and/or supplied as a pre-assembly or a kit of parts. The present invention encompasses all of these separate component parts and any assemblies thereof.

### BRIEF DESCRIPTION OF THE DRAWINGS

The invention will now be described further with reference to the accompanying drawings, in which:

FIG. 1 shows a schematic, cross-sectional view of a child safety seat including a fitting in accord with one aspect of the present invention;

FIG. 2 shows a perspective view of the base of a child safety seat including a fitting in accord with one aspect of the present invention;

FIG. 3 shows a perspective view of the base of FIG. 2 with child seat provided thereto and in which, the fitting engages an anchorage arrangement of a vehicle seat;

FIG. 4 shows a cross-sectional view of the base of the arrangement of FIG. 3 in which, the fitting of the child safety seat engages an anchorage arrangement of a vehicle seat;

FIG. 5 shows a perspective view of a set of fittings herein;

FIG. 6 shows a perspective view of a H-frame form fitting herein;

FIG. 7 shows a perspective view of a safety seat suitable for adaptation in accord with one aspect of the present invention;

FIG. 8 shows a perspective, exploded view of the child safety seat of FIG. 8;

FIG. 9a shows a perspective view of a variation of the H-frame form fitting of FIG. 6 herein;

FIG. 9b shows a detail of the H-frame form fitting of FIG. 9a;

FIG. 10 shows a child safety seat incorporating the H-frame form fitting of FIGS. 9a and 9b;

FIGS. 11a and 11b show details of the operation of the connectors of H-frame form fitting of FIG. 9a;

FIG. 12 shows a perspective view from the side of a further fitting herein;

FIG. 13 shows a perspective view of a H-form fitting herein having an adjuster to adjust the spacing of the pairs of first and second connectors thereof; and

FIG. 14 shows a perspective view of another H-form fitting herein having an adjuster to adjust the spacing of the pairs of first and second connectors thereof.

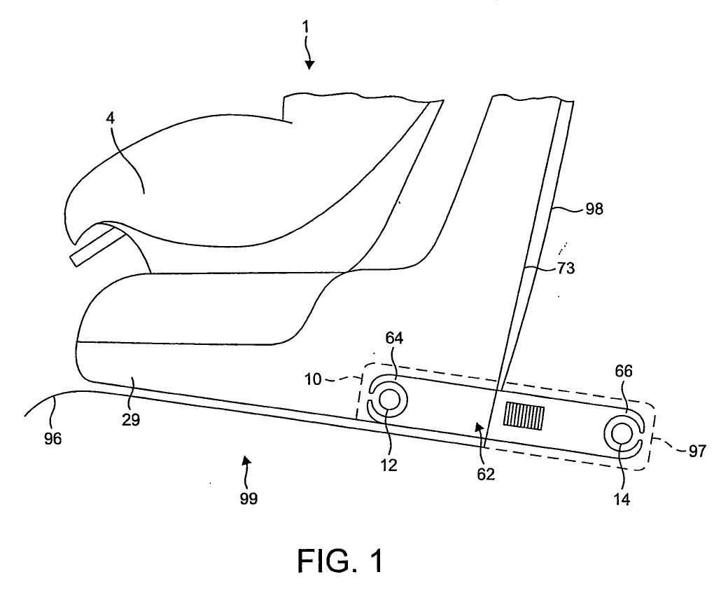

Referring now to the drawings, FIG. 1 illustrates a first child safety seat and fitting herein whose general arrangement is as follows:

Child safety seat 1 comprising seat shell 4 is arranged upon vehicle seat 99 such that its base 29 seats upon base vehicle seat portion 96 and its back 73 nestles against rear vehicle seat portion 98. Cutaway portion 10 of base 29 receives ‘cassette form’ fitting 62 provided at first end with first ISOfix standard type connector 64 for fixing to first ISOfix standard anchor bar 12 provided to seat base 29 and provided at second end with second ISOfix standard type connector 66 for fixing to second ISOfix standard anchor bar 14 provided to cutaway portion 97 of vehicle seat 99.

As shown in FIG. 1, the fitting 62 retainably fixes the base 29 to the vehicle seat 99 by means of the first 64, 12 and second 66, 14 ‘connector to anchor’ fittings. It may however, be appreciated that release of the first 64,12 ‘connector to anchor’ fitting will enable the seat 1 to be removed from the vehicle seat 99 (to which the cassette 62 is still attached). It may also be appreciated that release of the second 66, 14 ‘connector to anchor’ fitting also enables the seat 1 and still-attached cassette 62 to be removed from the vehicle seat 99. Release of both ‘connector to anchor’ fittings 64,12 and 66, 14 enables separation of child safety seat 1, cassette fitting 62 and vehicle seat 99 parts of the arrangement.

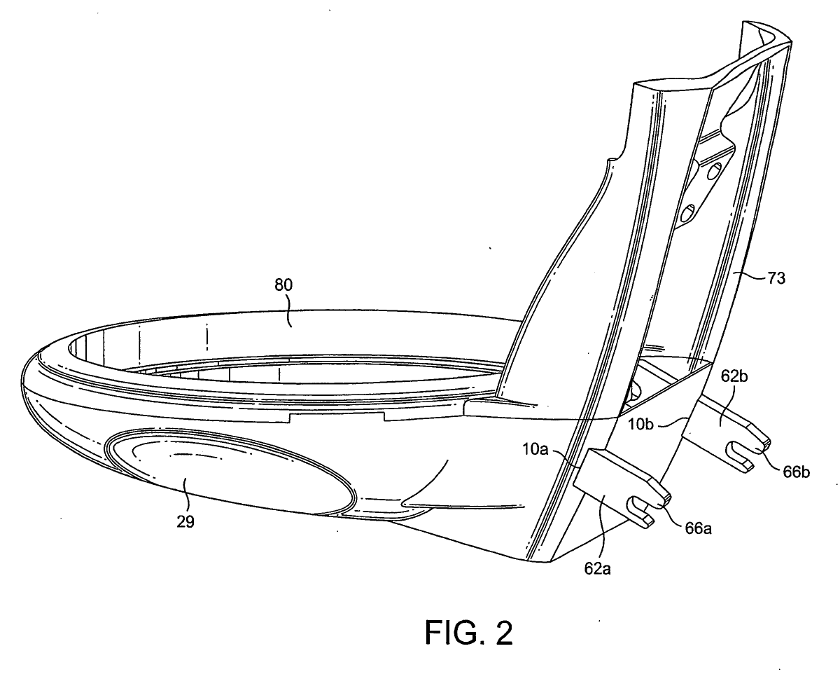

FIG. 2 illustrates a base for a child safety seat in combination with a fitting herein. It will be appreciated from the following description that the arrangement of the base of FIG. 2 is akin to that of the child safety seat of FIG. 1:

The child safety seat base of FIG. 2 comprises base portion 29 (which, in use seats upon seat portion of a vehicle seat) and back portion 73 (which, in use nestles against rear seat portion of a vehicle seat). Circular recess 80 is arranged for receipt of a child seat (not shown).

As in FIG. 1, cutaway portions 10a, 10b of base 29, each receive a ‘cassette form’ fitting 62a, 62b provided at first end with first ISOfix standard type connector for fixing to first ISOfix standard anchor bar provided to seat base (these features not visible) and provided at second end with second ISOfix standard type connector 66a, 66b for fixing to second ISOfix standard anchor bar of a vehicle seat (not shown). The ‘cassette’ fittings 62a, 62b are snugly received within the cutaway portions 10a, 10b such that only part of each fitting 62a, 62b protrudes.

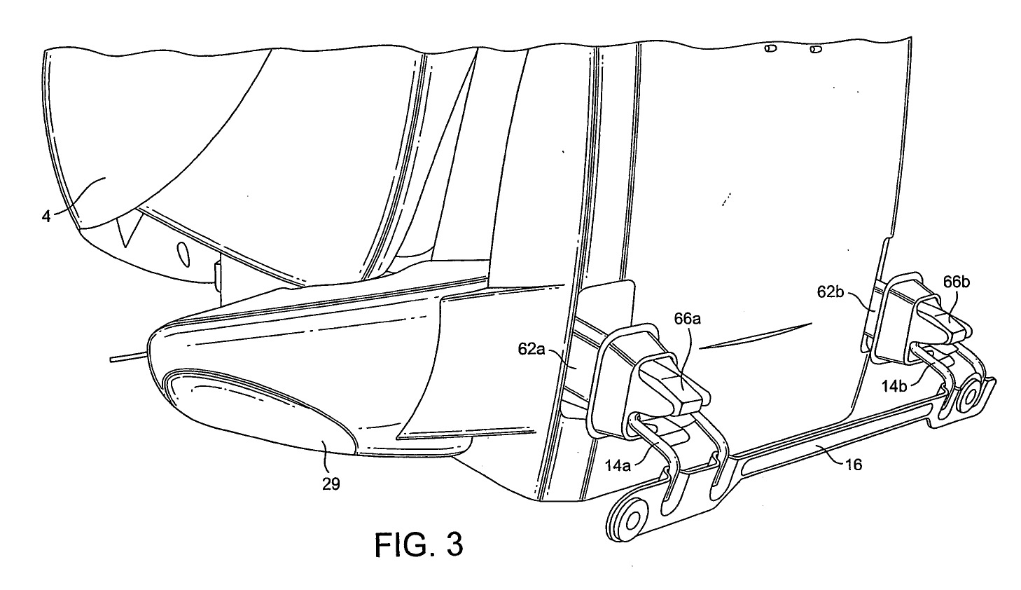

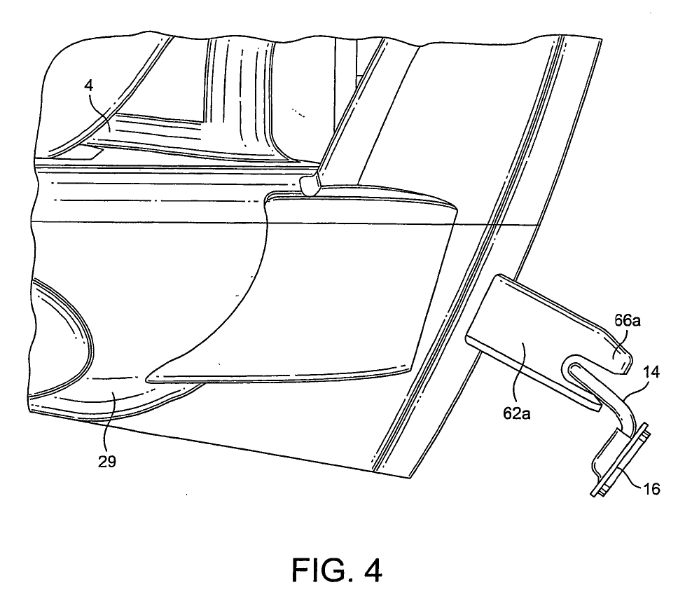

FIGS. 3 and 4 illustrate different views of the base 29 of FIG. 2, to which a child seat shell 4 is mounted. The fittings 62a, 62b interact with a vehicle seat anchor mounting 16 arrangement as now described:

The ‘cassette form’ fittings 62a, 62b (only one visible in FIG. 4) protrude from the base 29 such as to present second ISOfix standard type connectors 66a, 66b thereof for fixing of the seat to a vehicle seat (not shown). Each connector 66a, 66b fixes to an anchor bar 14a, 14b that stands proud from anchor mounting 16. Fixing is by a standard ‘connector to anchor’ mechanism in accord with the ISOfix standard.

It will be appreciated that, in use, the anchor mounting 16 is attached to a vehicle seat at a position between the base and backrest thereof (e.g. as shown in FIG. 1). It will also be appreciated that the anchor mounting 16 is arranged such that the anchor bars 14a, 14b are spaced and positioned to be in registration with protruding connectors 66a, 66b for ready engagement thereof.

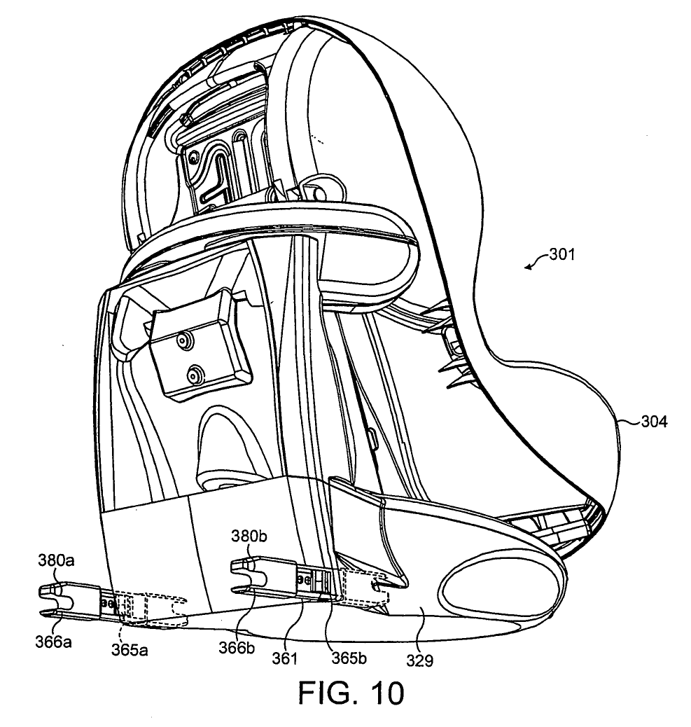

In FIG. 2 to 4, the fittings 62a, 62b protrude from some way up the back of the seat base. More usually, the fittings will be located lower down the back of the seat base such as close to the bottom of the back and parallel to it (e.g. as in FIG. 10).

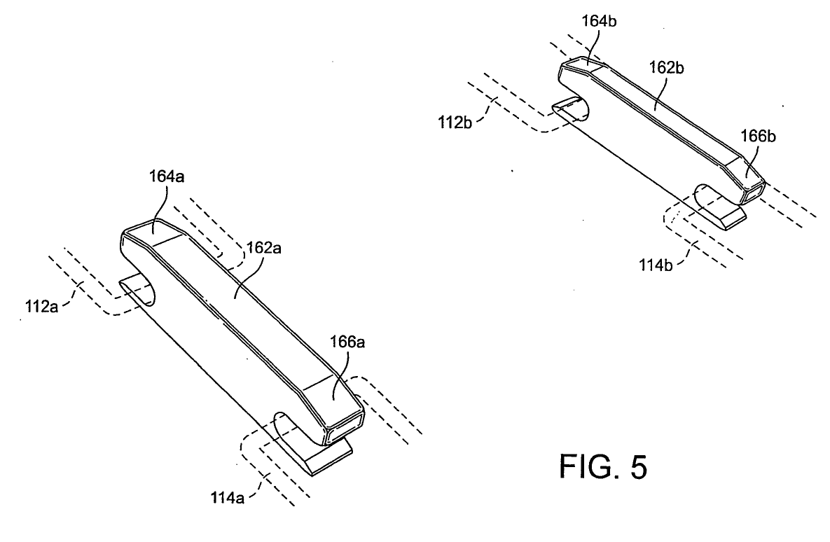

FIG. 5 illustrates a set of two separate fittings 162a, 162b suitable for use with a seat and vehicle seat anchor arrangement (e.g. as shown in FIG. 3).

Each ‘cassette form’ fitting 162a, 162b of the set is provided at first end with first ISOfix standard type connector 164a, 164b for fixing to first anchor bar 112a, 112b provided to seat base (not shown) and provided at second end with second ISOfix standard type connector 166a, 166b for fixing to second anchor bar 114a, 114b provided to a vehicle seat anchor arrangement.

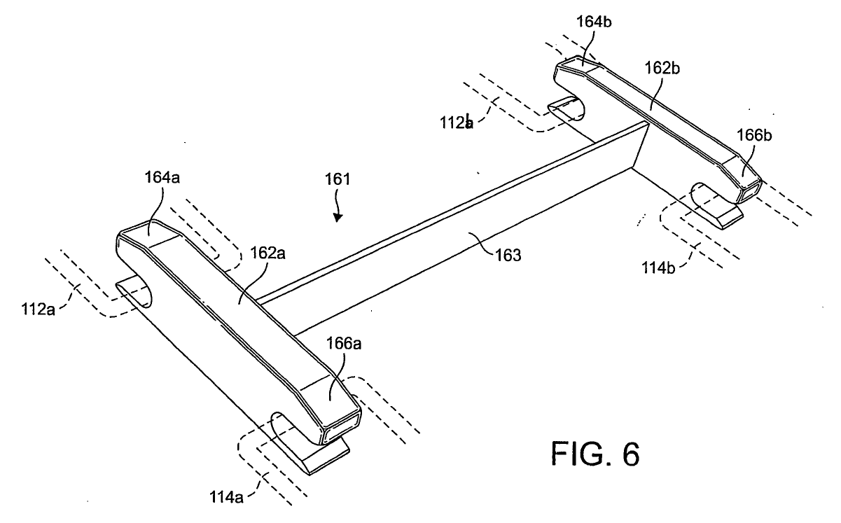

FIG. 6 illustrates a unitary body, H-frame fitting 161 suitable for use with a seat and vehicle seat anchor arrangement (e.g. as shown in FIG. 3).

The H-form body 161 supports two cassette form’ fittings 162a, 162b spaced from one another by a crosspiece 163. Each of the fittings 162a, 162b is provided at first end with a first ISOfix standard type connector 164a, 164b for fixing to first anchor bar 112a, 112b provided to seat base of a child safety seat (not shown) and provided at second end with second ISOfix standard type connector 166a, 166b for fixing to second anchor bar 114a, 114b provided to a vehicle seat anchor arrangement.

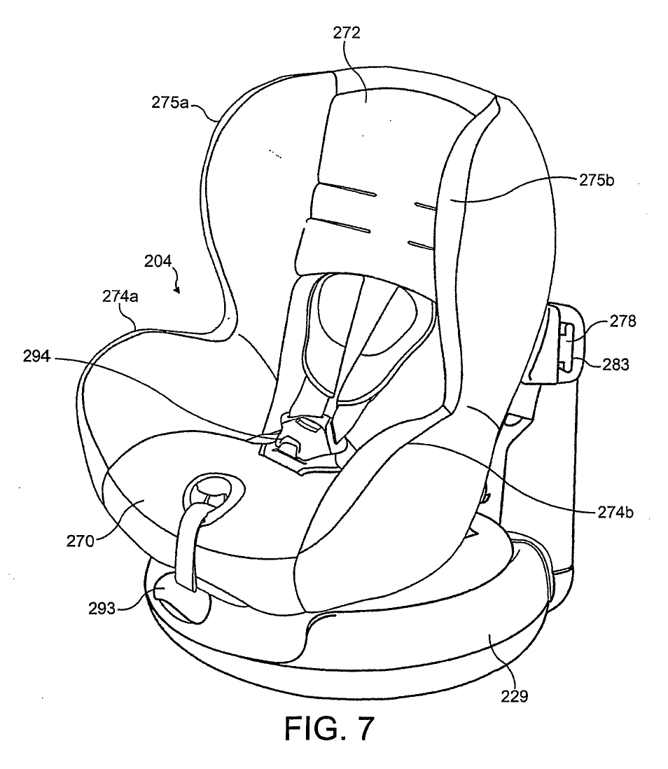

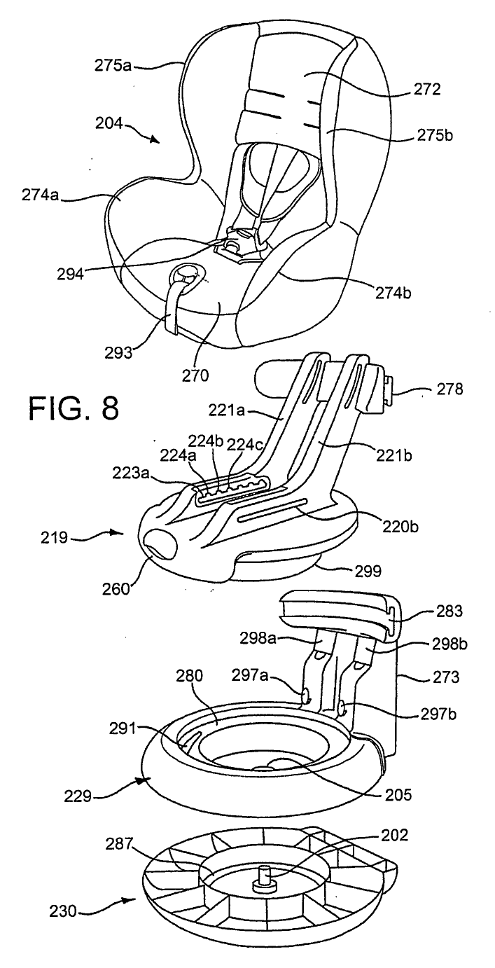

FIGS. 7 and 8 show different aspects of a safety seat suitable for adaptation in accord with the present invention, which provides for independent recline and rotational movement of a child seat relative to its base. This type of child safety seat and variations thereof is described in detail in Applicant's copending PCT patent application no. WO2005/000627.

Turning now to FIGS. 7 and 8, which show the child safety seat in perspective and exploded views, the child safety seat may be seen to comprise a seat shell 204 and a base 229. The seat shell 204 has a seat shell base 270 for receiving the child's bottom and thighs, a seat shell back 272 and lower 274a, 274b and upper 275a, 275b pairs of wings, which provide protection in the case of vehicle accident. The seat shell 204 is also provided with buckles/adjusters 293, 294 for securing a child in the seat.

With particular reference to FIG. 8, the child safety seat may be seen to comprise four main components: seat shell 204; recline module 219; base 229 and rotational plinth 230.

It will be appreciated from the description hereinafter, that the recline module 219 has three main functions: to act as a mounting for the seat shell 204; to allow secure and steady reclining of the seat shell 204; and to act as one half of a rotating joint which allows itself and the seat shell 204 attached to it to rotate as a single entity about a generally vertical axis.

Recline module 219 attaches to seat shell 204 unit by way of a slider mechanism comprising dual sets 220a (not visible), 220b and 223a, 223b (not visible) of runners located on arms 221 a, 221b of the module 219. The second set of runners 223a is provided with plural notches 224a, 224b, 224c, each notch corresponding to a defined position of recline. It will be appreciated that each set of runners 220b, 223a receives pins (not visible) located on the underside of the seat shell 204 and therefore that this arrangement enables movement of the seat shell 204 relative to the recline module 219 and base 229 to various defined recline positions.

Recline module 219 couples permanently to base 229 at two main points of coupling. Firstly, central spindle 202 protrudes from rotational plinth 230 and feeds through hole 205 in the base 229 and a similar hole in recline module 219 (not visible) where a capping bolt (again not visible) is applied. The capping bolt is applied in such a way that recline module 219 is rotatable about the base 229 and rotational plinth 230. Secondly, curved slide rail 278 is retainably received by curved track 283 located on the inner part of the back 273 of the base 229. In use, these two points of joining maintain recline module 219, base 229 and rotational plinth as a defined sub-assembly. In particular, receipt of the curved slide rail 278 by the curved track 283 is arranged such that a degree of coupling is retained by this join even when the recline module 219 is rotated by 90° relative to the base 229 and rotational plinth 230.

Operation of the rotational mechanism as described is by handle 260, which is pulled outwards to release a locking pin (not visible) which protrudes from the recline module 219 into the base 229 and the release of which allows the recline module to rotate relative thereto. The handle and locking pin are spring-loaded such that the spring (not visible) returns the handle 260 and locking pin when the handle 260 is released. The locking pin may therefore be used to lock the recline module in either the forward facing or 90° clockwise or anti-clockwise rotated positions.

As will be appreciated from the description herein, the base 229 has three main functions: to act as the main anchor point for the whole unit to the vehicle seat; to define the angle of the backrest part of the seat shell 204 when received in the vehicle seat to create a suitable geometry for the rotation function to operate successfully; and to act as the second half of a rotating junction providing an area for the recline module 219 and seat shell 204 to rotate.

In use, the base is securely fitted to a vehicle seat by use of a two-point seat belt fixing system at fixing points 297a, 297b and 298a, 298b. Metal locking plate 291 for the previously described rotation locking pin (not visible) is set in to a circular recess 280 provided to the inner part of the base 229.

The principal function of the rotational plinth 230, which sits on the vehicle seat and receives the other parts of the child safety seat, is to act as a platform which defines the angle of the seat shell 204 relative to the vehicle seat to create a suitable geometry for the rotation function to operate successfully. It also provides central spindle 202, which defines the axis of rotation for recline module 219 and seat shell 204. The plinth 230 is also provided with nylon bearing 287, which defines a track, about which the base 299 of recline module 219 can run freely. Additionally, internal webbing is present as on all mouldings to add strength.

It will be appreciated that the arrangement of the child safety seat of FIGS. 7 and 8 advantageously enables the seat shell 204 to be rotated in either direction (i.e. clockwise or anticlockwise) whilst in either the fully upright or any recline position.

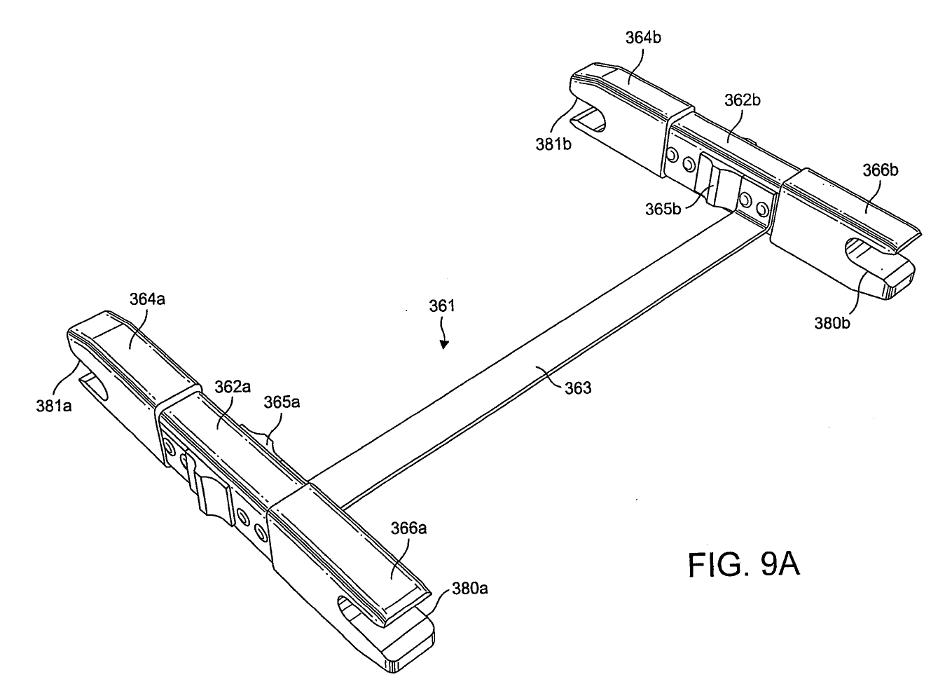

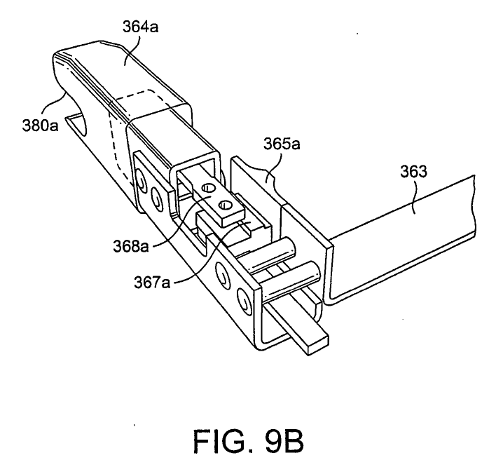

FIG. 9a illustrates a unitary body, H-frame fitting 361 suitable for use with a seat and vehicle seat anchor arrangement (e.g. as shown in FIG. 3). FIG. 9b shows a detail of this H-frame form fitting. It will be appreciated that the H-frame form fitting of FIGS. 9a and 9b is a variation of that shown at FIG. 6.

The H-frame body 361 supports two cassette form’ fittings 362a, 362b spaced from one another by a crosspiece 363. Each of the fittings 362a, 362b is provided at first end with first ISOfix standard type connector 364a, 364b for fixing to first anchor bar provided to seat base (not shown) and provided at second end with second ISOfix standard type connector 366a, 366b for fixing to second anchor bar provided to a vehicle seat anchor arrangement. It may additionally be seen that each connector 364a, 364b; 366a, 366b lies recessed within open jaw 381a, 381b; 380a, 380b, each dimensioned such for receipt an ISOfix anchor bar and to guide the anchor bar for connecting with the respective connector 364a, 364b; 366a, 366b.

Respective release knobbed latches 365a, 365b are provided to assist opening and closing of seat base anchor connectors 364a, 364b. In use, these connectors 364a, 364b are otherwise difficult to access since they locate deep within a cavity provided to the seat base 329 as may be seen by reference to FIG. 10, which shows a child safety seat 301 having seat 304 and including H-frame form fitting 361. Similar release knobs are provided on the outer sides of the H-frame form fitting for opening and closing of child safety seat anchor connectors 366a, 366b.

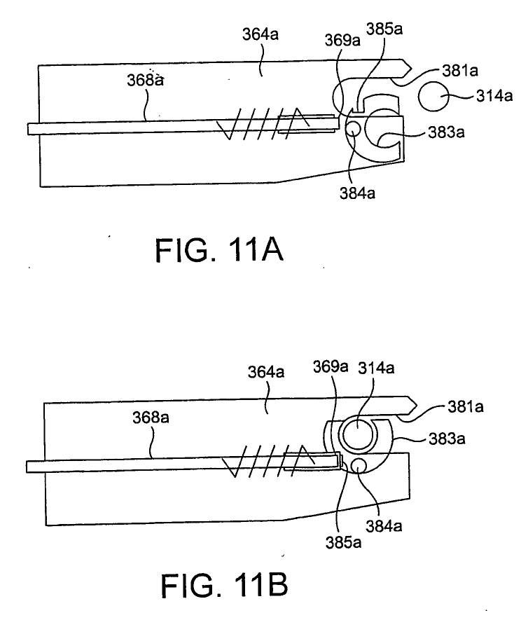

Operation of the release latches 365a, 365b may be better understood by reference to FIG. 9b (only one latch visible). Each latch 365a is slidably mounted such that user movement of the latch 365a (along the axis defined by the elongate form of the fitting) results in movement of a block component 367a thereof that in turn, moves arm 368a, to which the block 367a is fixed. Movement of the arm 368a results in engagement/disengagement of the ISOfix mechanism of the connector 364a as may be seen by reference to FIGS. 11a and 11b. Thus, in use the latch 365a may be used to engage/disengage the connector 364a from an anchor (not shown) of the seat base 329.

In more detail, FIGS. 11a and 11b shows representative ISOfix connector 364a mechanism in respective ‘anchor bar unengaged’ and ‘anchor bar engaged’ modes. It will be seen that open jaw 381a is sized and shaped for receipt of anchor bar 314a and to guide the anchor bar 314a to contact C-form locking member 383a that rotationally mounts at pivot 384a. It will be appreciated that as the anchor bar 314a contacts the C-form locking member 383a, that C-form member 383a is caused to rotate to enclose the anchor bar 314a. In turn, tip 369a of sprung loaded locking arm 368a is caused to seat within notch 385a to lock further movement of the C-form locking member 383a and thus, to lock the anchor bar 314a in place. Such seating of the tip 369a within the notch 385a of the C-form member 383, and hence the locking of the anchor bar 314a within the connector 364a, is reversibly released by means of the latch mechanism as already described above in relation to FIGS. 9a and 9b.

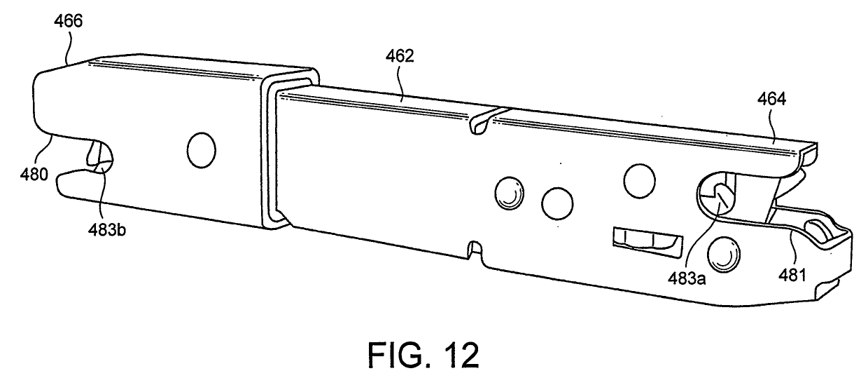

FIG. 12 shows a fitting herein that may be understood to be a variation of the fittings of FIG. 5. In use, a set of two separate fittings of the type shown in FIG. 12 would typically be employed in a fashion similar to that shown in FIG. 5.

The body 462 of the fitting is provided at first end with first ISOfix standard type connector 464 for fixing to first anchor bar (not shown) provided to a child safety seat base. It will be seen that the first connector 464 has an open jaw 481 form and is provided with a C-form member 483a locking mechanism (e.g. as described in relation to FIGS. 11a and 11b)

The body is further provided at a second end with second ISOfix standard type connector 466 for fixing to an anchor bar (not shown) provided to a vehicle seat anchor arrangement. It will be seen that the second connector 466 has an open jaw 480 form, which defines an overall slightly different external profile to the open jaw 481 of the first connector 464 end, and is again provided with a C-form member 483b locking mechanism (e.g. as described in relation to FIGS. 11a and 11b)

Given variability in the location and spacing of anchorage(s) found with different child safety seats and vehicle types, it is advantageous for the fitting to be able to provide for variable and/or adjustable spacing of the first and second connectors.

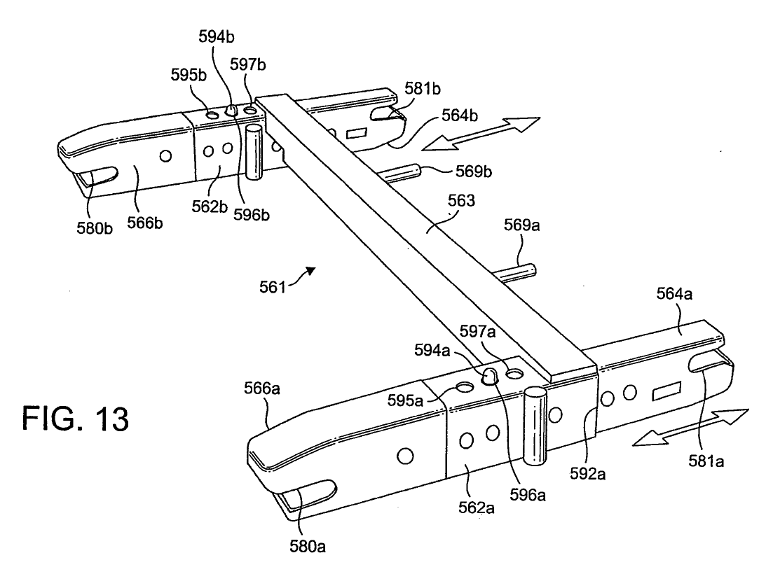

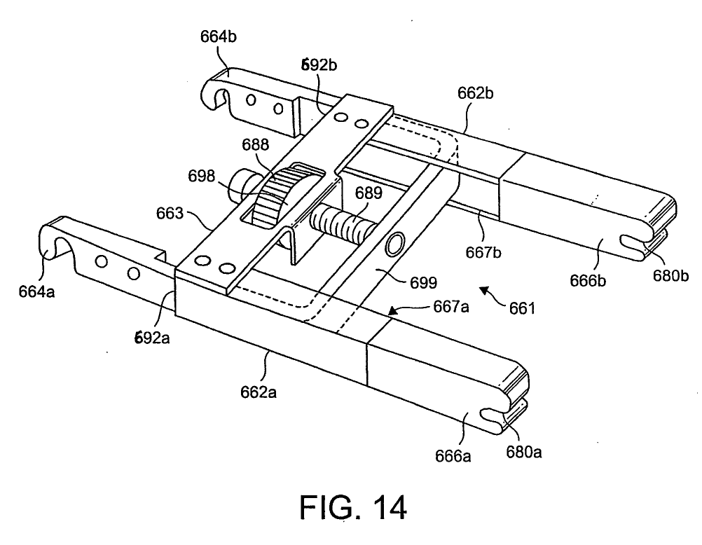

FIGS. 13 and 14 show H-form fittings herein, each provided with a different kind of adjuster to adjust the spacing of the pairs of first and second connectors thereof.

In more detail, FIG. 13 shows a unitary body, H-frame fitting 561 suitable for use with a seat and vehicle seat anchor arrangement (e.g. as shown in FIG. 3). The H-frame body 561 supports two cassette form’ fittings 562a, 562b spaced from one another by box girder form crosspiece 563. The crosspiece 563 is itself, provided with mounting arms 569a, 569b suitable for receipt by corresponding mountings (not shown) that would be provided to the underside of a child safety seat. Each of the fittings 562a, 562b is provided at first end with first ISOfix standard type connector 564a, 564b for fixing to first anchor bar provided to seat base (not shown) of a child safety seat and provided at second end with second ISOfix standard type connector 566a, 566b for fixing to second anchor bar provided to a vehicle seat anchor arrangement (again not shown). The open jaw 581 a, 581b; 580a, 580b, form of each connector 564a, 564b; 566a, 566b end may also be seen.

To achieve the required adjustability of spacing, the first connector 564a, 564b part of the body of the fitting 561 is mounted such that it is movable with respect to the second connector 566a, 566b part. Thus, the first connector part 564a, 564b is received within box form end 592a, 592b of the second connector 566a, 566b part for movement there within. Stepped adjustment between three distinct spacing positions is achieved by the use of sprung-loaded spacer pin 594a, 594b that is movable between three defined spacing positions 595-7a; 595-7b. Alteration of the spacing position thus, requires depressing each spacer pin 594a, 594b to disengage it from its present spacing position (i.e. position 596a, 596b as shown) and relative movement of the respective connector parts 564a, 564b and 566a, 566b until the pin 594a, 594b engages with an alternative spacing position. Use of sprung-loaded spacer pin type mechanism for stepped spacing adjustment is for example, known for use in respect of garden umbrellas.

FIG. 14 also shows a unitary body, H-frame fitting 661 suitable for use with a seat and vehicle seat anchor arrangement (e.g. as shown in FIG. 3). The H-frame body 661 supports two cassette form’ fittings 662a, 662b spaced from one another by crosspiece 663. Each of the fittings 662a, 662b is provided at first end with first hook form connector 664a, 664b for fixing to first anchor bar provided to seat base (not shown) of a child safety seat and provided at second end with second ISOfix standard type connector 666a, 666b for fixing to second anchor bar provided to a vehicle seat anchor arrangement (again not shown). The open jaw 680a, 680b, form of each second connector 666a, 666b end may be seen.

To achieve the required adjustability of spacing, it will be seen that the first connector 664a, 664b part of the body of the fitting 661 is mounted such that it is movable with respect to the second connector 666a, 666b part. Thus, first connector parts 664a, 664b are received within box form end 692a, 692b of the second connector 666a, 666b part and movable there within. It will be further seen that the first connector 664a, 664b parts are joined by end bar 699 that is movable within channels 667a, 667b provided to the inner sides of the second connector 666a, 666b parts. End bar 699 is also coupled to crosspiece 663 by means of screw adjuster 698.

Continuous adjustment of spacing of the first connector 664a, 664b and second connector 666a, 666b part is by use of the screw adjuster 698. In more detail, the screw adjuster 698 comprises main screw 689 whose forward end fixedly attaches to the end bar 699. Body of the main screw 689 is provided with control screw 688, which threadedly mounts thereon such as to protrude from the crosspiece 663 as shown. By rotating the control screw 688 (along the thread of the main screw) the spacing between the first connector 664a, 664b parts and the crosspiece 663, and hence second connector 666a, 666b parts may be screw adjusted until end bar 699 contacts the vehicle seat squab (not shown). It will be appreciated that in use, end bar 699 is in the same plane as the back of the child safety seat.

The application of which this description and claims form part may be used as a basis for priority in respect of any subsequent application. The claims of such subsequent application may be directed to any feature or combination of features described therein. They may take the form of product, method or use claims and may include, by way of example and without limitation, one or more of the following claims:

1. A fitting for a child safety seat for use with a vehicle seat comprising:
a body;
provided to said body, a first connector for connecting to an anchorage of a child safety seat; and
provided to the body and spaced from the first connector, a second connector for connecting to an anchorage of a vehicle seat.

2. A fitting according to claim 1, wherein said body has elongate form and the first and second connectors are provided at opposing ends thereof.

3. A fitting according to either of claim 1, comprising a first body part, a second body part and a crosspiece therebetween to define an overall H-form body; and provided to each body part, a first connector for connecting to an anchorage of a child safety seat; and spaced from the first connector, a second connector for connecting to an anchorage of a vehicle seat.

4. A fitting according to claim 3, wherein the crosspiece has box girder form.

5. A fitting according to claim 1, wherein the body is provided with guide elements for guiding the first and second connectors to connect with their respective anchorages.

6. A fitting according to claim 1, wherein the second connector conforms to the ISOfix standard.

7. A fitting according to claim 6, wherein both the first and second connectors conform to the ISOfix standard.

8. A fitting according to claim 1, wherein the body comprises an adjuster for adjusting the spacing between the first and second connectors.

9. A fitting according to claim 8, wherein said adjuster allows for continuous adjustment of the spacing over a defined range of spacing distances.

10. A fitting according to claim 9, wherein the spacing adjuster comprises a screw adjuster.

11. A fitting according to claim 8, wherein the adjuster allows for stepped adjustment of the spacing over a defined range of spacing distances.

12. A fitting according to claim 11, wherein the spacing adjuster comprises a ratchet and pawl mechanism.

13. A fitting according to claim 11, wherein the spacing adjuster comprises a sprung-loaded spacer pin that is movable between defined spacing positions.

14. A fitting according to claim 1, wherein one or more of the first and second connectors locates within a recess defined by an open jaw.

15. A fitting according to claim 1, wherein one or more of the first and second connectors is arranged such as to automatically lock onto the anchorages on being brought into contact therewith.

16. A fitting according to claim 1, additionally comprising one or more releases for ready release of one or more of the first or second connectors.

17. A fitting according to claim 16, wherein each release comprises a user actuator that couples via a release mechanism to a connector.

18. A fitting according to claim 18, wherein the release mechanism comprises a latch mechanism.

19. A child safety seat for use with a vehicle seat comprising:
a base arranged for secure fitting to said vehicle seat;
a child seat shell arranged for secure placement of a child therein; and
a mounting for mounting said child seat shell to said base, wherein said base includes an anchorage for connecting a connector of a fitting thereto.

20. A child safety seat according to claim 19, wherein said mounting provides for reversible reclining movement of the child seat shell relative to the base from an initial position to one or more reclined positions.

21. A child safety seat according to claim 19, wherein the mounting provides for reversible rotational movement of the child seat shell relative to the base.

22. A child safety seat according to claim 19, wherein the anchorage comprises an anchor bar.

23. A child safety seat according to claim 22, wherein said anchor bar conforms to the ISOfix standard.

24. A child safety seat according to claim 19, wherein the anchorage locates within a cavity sized and shaped for receipt of said connector of said fitting.

25. A child safety seat according to claim 24, wherein the anchorage is recessed within said cavity.

26. A child safety seat according to claim 19, wherein the base of the child safety seat is provided with plural anchorages, each for anchoring a connector of a fitting thereto.

27. A child safety seat according claim 19, wherein the base of the child safety seat is provided with a single anchorage of sufficient length to allow for anchoring of plural connectors of a fitting thereto.

28. A base sub-assembly for child safety seat for use with a vehicle seat comprising:
a base arranged for secure fitting to said vehicle seat; and
a mounting for mounting a child seat shell to said base,
wherein said base includes an anchorage for connecting a connector of a fitting thereto.

29. Kit of parts comprising a fitting according to claim 1; and a child safety seat according to claim 19.
